(19) United States
(12) Patent Application Publication
(10) Pub. No.: US 2021/0105379 A1
(43) Pub. Date: Apr. 8, 2021

(54) IMAGE FORMING APPARATUS, STORAGE MEDIUM, AND CONTROL METHOD

(71) Applicant: SHARP KABUSHIKI KAISHA, Sakai City (JP)

(72) Inventor: TATSUYA WATABE, Sakai City (JP)

(21) Appl. No.: 17/038,617

(22) Filed: Sep. 30, 2020

(30) Foreign Application Priority Data
Oct. 7, 2019 (JP) 2019-184400

(51) Int. Cl. H04N 1/32

(52) U.S. Cl. CPC H04N 1/32122; H04N 1/32459; H04N 1/32096

(57) ABSTRACT

An image forming apparatus receives an input of duplicate data obtained by duplicating: common information applicable also to another image forming apparatus, out of apparatus setting information about the image forming apparatus; unique information applicable only to the image forming apparatus, out of the apparatus setting information; and identification information for identifying the image forming apparatus, determines, if the duplicate data is input, whether identification information on a duplicated data side included in the duplicated data and identification information on an apparatus side stored in a storage match, and writes, if it is determined that the identification information on the duplicated data side and the identification information on the apparatus side match, the unique information included in the duplicated data into the storage.

### BACKGROUND OF THE INVENTION

### Field of the Invention

The present invention relates to an image forming apparatus, a storage medium, and a control method, and more particularly, for example, relates to an image forming apparatus equipped with a function of outputting duplicate data of setting information for the image forming apparatus and a function of receiving an input of duplicate data, a storage medium, and a control method.

### Description of the Background Art

An example of this type of a conventional technology is disclosed in Japanese Unexamined Patent Application Publication No. 2007-266964. In the above conventional image processing apparatus, a so-called device cloning is executed in which an image of setting data for setting various setting values for a function of such an image processing apparatus is formed on a sheet to create a clone sheet, and the setting data of the clone sheet read by an image reader is set to the image processing apparatus itself as setting data for the corresponding function. In such a conventional image processing apparatus, the setting data of the clone sheet utilized for the device cloning includes setting data set as a result of being selected from a selection previously prepared for each function, the setting data input through a user input such as address data, and device model information of the image processing apparatus and log information of the image processing apparatus.

In the above conventional image processing apparatus, the device model information of the image processing apparatus is included in the duplicate data, and thus, when the duplicate data is applied to the same image forming apparatus, it is possible to use the duplicate data as backup data, which is convenient.

However, in the above conventional image processing apparatus, various information unique to the image processing apparatus such as the device model information of the image processing apparatus may be possibly written into another image forming apparatus, and therefore, different image processing apparatuses may hold the same device model information. Therefore, there is room for improvement in terms of safety.

Accordingly, a primary object of the present invention is to provide a novel image forming apparatus, storage medium, and control method.

Another object of the present invention is to provide an image forming apparatus, a storage medium, and a control method by which it is possible to achieve both convenience and safety when a device cloning is executed.

### SUMMARY OF THE INVENTION

A first aspect of the present invention is an image forming apparatus including an image former that forms an image on a recording medium and a storage, and including an inputter, a determiner, and a writer. The inputter receives an input of duplicate data obtained by duplicating common information applicable also to another image forming apparatus, out of setting information about the image forming apparatus, unique information applicable only to the image forming apparatus, out of the setting information, and identification information for identifying the image forming apparatus. If the duplicate data is input, the determiner determines whether identification information on a duplicate data side included in the duplicate data and identification information on an apparatus side stored in the storage match. If it is determined that the identification information on the duplicate data side and the identification information on the apparatus side match, the writer writes the unique information included in the input duplicate data into the storage.

A second aspect of the present invention is the image forming apparatus according to the first aspect. If the duplicate data is input, the writer writes the common information included in the duplicate data into the storage.

A third aspect of the present invention is the image forming apparatus according to the first or second aspect. The unique information includes specific unique information, the image forming apparatus further includes a setter that sets whether to write the specific unique information, and the writer writes the specific unique information into the storage if there is a setting to write the specific information.

A fourth aspect of the present invention is an image forming apparatus including an image former that forms an image on a recording medium, and the image forming apparatus includes a storage and an outputter. The storage stores common information applicable also to another image forming apparatus, out of setting information about the image forming apparatus, unique information applicable only to the image forming apparatus, out of the setting information, and identification information for identifying the image forming apparatus. The outputter outputs duplicate data obtained by duplicating the common information, the unique information, and the identification information.

A fifth aspect of the present invention is a non-transitory storage medium for storing a control program of an image forming apparatus including an image former that forms an image on a recording medium and a storage. The control program causes a processor of the image forming apparatus to execute receiving an input of duplicate data obtained by duplicating common information applicable also to another image forming apparatus, out of setting information about the image forming apparatus, unique information applicable only to the image forming apparatus, out of the setting information, and identification information for identifying the image forming apparatus, determining, if the duplicate data is input, whether identification information on a duplicate data side included in the duplicate data and identification information on an apparatus side stored in the storage match, and writing, if it is determined that the identification information on the duplicate data side and the identification information on the apparatus side match, the unique information included in the input duplicate data into the storage.

A sixth aspect of the present invention is a control method of an image forming apparatus including an image former that forms an image on a recording medium. The method includes (a) receiving an input of duplicate data obtained by duplicating common information applicable also to another image forming apparatus, out of setting information about the image forming apparatus, unique information applicable only to the image forming apparatus, out of the setting information, and identification information for identifying the image forming apparatus, (b) determining, if the duplicate data is input, whether identification information on a duplicate data side included in the duplicate data and identification information on an apparatus side stored in the storage match, and (c) writing, if it is determined that the identification information on the duplicate data side and the identification information on the apparatus side match, the unique information included in the input duplicate data into the storage.

According to the present invention, it is possible to achieve both convenience and safety when a device cloning is executed.

The above object, other objects, features, and advantages of the present invention will be more apparent from the following detailed description of embodiments with reference to the drawings.

### BRIEF DESCRIPTION OF THE DRAWINGS

FIG. 1 is a block diagram illustrating an electrical configuration of an image forming apparatus of the present invention;

FIG. 2 is an illustrative view illustrating an example of a memory map of a RAM illustrated in FIG. 1;

FIG. 3 is a flowchart illustrating an example of a duplicate data output process of a CPU illustrated in FIG. 1;

FIG. 4 is a flowchart illustrating an example of a duplicate data writing process of the CPU illustrated in FIG. 1;

FIG. 5 is an illustrative view illustrating an example of a setting screen of a second embodiment; and

FIG. 6 is a flowchart illustrating an example of a duplicate data writing process of the second embodiment.

### DESCRIPTION OF THE PREFERRED EMBODIMENTS

### First Embodiment

An image forming apparatus 10 according to a first embodiment is a multifunction peripheral (MFP) including a copying function, a printer function, a scanner function, and a facsimile (FAX) function. The present invention is applicable not only to such a multifunction peripheral but also to another image forming apparatus such as a copying machine (copier), a printing apparatus (printer), and a facsimile.

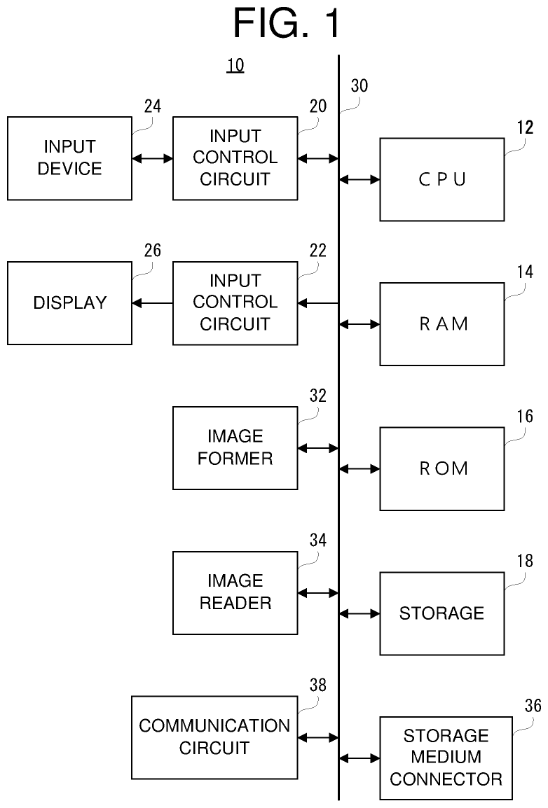

FIG. 1 is a block diagram illustrating an electrical configuration of the image forming apparatus 10 of the present invention. Referring to FIG. 1, the image forming apparatus 10 includes a CPU 12. The CPU 12 is connected with a RAM 14, a ROM 16, a storage 18, an input control circuit 20, a display control circuit 22, an image former 32, an image reader 34, a storage medium connector 36, and a communication circuit 38, via a bus 30. An input device 24 is connected to the input control circuit 20, and a display 26 is connected to the display control circuit 22. For example, an LCD or an electro-luminescence (EL) display may be employed for the display 26.

The CPU 12 manages an overall control of the image forming apparatus 10. The RAM 14 is used as a work area and a buffer area of the CPU 12. The ROM 16 is one of storage devices of the image forming apparatus 10 and stores programs of the image forming apparatus 10 and default values for various types of information about the image forming apparatus 10.

The storage 18 is a main storage device of the image forming apparatus 10, and includes a non-volatile memory such as an HDD and an EPPROM. The storage 18 may be configured to include the RAM 14 and the ROM 16. The storage 18 stores data for a control program for controlling operations of components of the image forming apparatus 10 by the CPU 12, image (display image) data for various types of screens, data necessary for executing the control program, and the like.

The input device 24 includes a touch panel, and a hardware-type operation button or operation key (hardware key). The touch panel is a general-purpose touch panel, and may employ any type of the touch panel such as an electrostatic capacitance type, an electromagnetic induction type, a resistance film type, and an infrared type. The touch panel may be provided on a display surface of the display 26 or may be provided separately from the display 26. A touch display in which the touch panel and the display 26 are integrally formed may be provided. If the touch panel is provided, a software key such as various types of buttons and icons is displayed on the display 26.

The software key means, for example, a key or an icon reproduced in a software fashion on the display surface of the display 26. On the other hand, the hardware key means a key or a push button provided as a physical device.

The input control circuit 20 outputs an operation signal or operation data corresponding to an input operation into the input device 24, to the CPU 12. The input control circuit 20 applies a voltage or the like required for the touch panel included in the input device 24, detects a touch operation (touch input) within an effective touch range of the touch panel, and outputs, to the CPU 12, touch coordinate data indicating a position of the touch input. The input control circuit 20 outputs, to the CPU 12, an operation signal or operation data corresponding to an operation on the operation button or the hardware key included in the input device 24.

The display control circuit 22 includes a GPU and a VRAM, and under an instruction of the CPU 12, the GPU uses image generation data stored in the RAM 14 to generate, in the VRAM, display image data for displaying various types of screens on the display 26, and outputs the generated display image data onto the display 26. For example, a home screen, which is a screen for selecting a desired job from various types of jobs executable by the image forming apparatus 10, and the like are displayed on the display 26. In this case, the job means copying (including scanning of a document), printing, facsimile (FAX) transmission and reception, and scanning.

The image former (printing device) 32 is a general-purpose laser printer, includes a photoconductor, a charger, an exposure device, a developing device, a transfer device, and a fixing device, and prints an image corresponding to print data processed by an image processing circuit onto recording paper (a sheet), or the like. In this case, the image former 32 may be configured by an ink jet printer instead of a laser printer.

Although a detailed description is omitted, the image former 32 is equipped with a color printing function, and includes an image formation station including a photoconductor, a charger, and a developing device, for each color of Y (yellow), M (magenta), C (cyan), and K (black).

The image reader 34 includes a light source, a plurality of mirrors, an imaging lens, and a line sensor. The image reader 34 exposes a document surface with light from the light source, and guides reflected light reflected from the document surface to the imaging lens by the plurality of mirrors. The reflected light is imaged on a light receiving element of the line sensor by the imaging lens. The line sensor detects luminance and chromaticity of the reflected light imaged on the light receiving element to generate read image data based on an image on the document surface.

The storage medium connector 36 includes a mount (for example, a drive and a memory slot) on which various types of storage media are mounted. Various types of storage media include an optical disk (such as CD-R, DVD-R, and BD-R) and a flash memory (such as a USB memory, an SD memory card, and a memory stick). It is noted that the optical disc is mounted in the drive. The flash memory is mounted in the memory slot.

The communication circuit 38 is a communication circuit for connecting to a network such as a LAN and the Internet. The communication circuit 38 is a wired communication circuit or a wireless communication circuit, and communicates with an external computer via a network by using a protocol such as TCP/IP according to an instruction from the CPU 12.

An electrical configuration of the image forming apparatus 10 illustrated in FIG. 1 is merely an example, and is not limiting. For example, a hardware-type keyboard as another inputter may be connected to the image forming apparatus 10.

In the conventional image forming apparatus having such a configuration, if setting data (duplicate data) for setting various types of setting values about a function of an image processing apparatus is input, a so-called device cloning may be performed in which the setting data is set to the image processing apparatus itself as setting data about the corresponding function. The duplicate data used in the device cloning includes not only setting information for setting various types of setting values about the function of the image processing apparatus but also device model information of the image processing apparatus, log information of the image processing apparatus, and the like. In such a conventional image processing apparatus, the device model information of the image processing apparatus is included in the duplicate data, and thus, the duplicate data may be used as backup data, which is convenient.

However, in the conventional image forming apparatus, the device model information of the image processing apparatus may be possibly transplanted (copied) to another image processing apparatus, and as a result, different image processing apparatuses may hold the same device model information. Therefore, there is room for improvement in terms of safety.

Therefore, the image forming apparatus 10 according to the first embodiment does not allow different image processing apparatuses to hold the same device model information when a device cloning is performed. A flow of the device cloning according to the present embodiment will be described below.

In the image forming apparatus 10 according to the first embodiment, in receiving a predetermined user operation (output operation) for instructing output of duplicate data (cloning data) utilized in the device cloning, duplicate data at a time of receiving the output operation is output. The duplicate data output from the image forming apparatus 10 is stored in various types of storage media via the storage medium connector 36, or stored in an external computer such as another image forming apparatus or a server via the communication circuit 38 and the network. An output destination of the duplicate data is set in advance.

The duplicate data includes setting information about the image forming apparatus 10 (hereinafter, sometimes simply referred to as “apparatus setting information”) and identification information (discrimination information). It is noted that the duplicate data is data obtained by duplicating the apparatus setting information and the identification information stored in the image forming apparatus 10 when the output operation is received.

The apparatus setting information includes information (operation condition information) about an operating condition of the image forming apparatus when various types of jobs are executed, information such as an address of a partner to transmit or receive data (communication partner information), information of a registered user registered in advance (user information), information about a machine name (machine name information) of the image forming apparatus 10 from which the duplicate data is generated (outputted), information about an IP address (IP address information) in the network of the image forming apparatus 10 from which the duplicate data is output, and firmware version information. The apparatus setting information is stored in the storage 18, for example.

For example, the operation condition information includes information about operating conditions (settings) for each of a color setting, a document orientation, a double-sided copying, a magnification, a copy density, and a page aggregation when a copy job is executed. The operation condition information includes information about various types of operating conditions when each of a print job, a facsimile job, and a scan job is executed.

However, the apparatus setting information includes not only common information applicable not only to an image forming apparatus (first apparatus) from which the duplicate data is output but also to another image forming apparatus (second apparatus), and unique information applicable only to the image forming apparatus (first apparatus) from which the duplicate data is output. For example, the common information corresponds to the operation condition information, the communication partner information, the user information, and the like, out of the above-described apparatus setting information, or the unique information corresponds to the machine name information, the IP address information, and the like.

The identification information is information for identifying the image forming apparatus 10 from which the duplicate data is output. For example, the identification information includes information about a model name (model name information) of the image forming apparatus 10 and information about a serial number (serial number information) thereof. The identification information is stored in a read-only (unwritable or unchangeable) state, and is stored in the ROM 16, for example.

In the image forming apparatus 10, the duplicate data may be input from outside. For example, in the image forming apparatus 10, when duplicate data stored in a storage medium is read via the storage medium connector 36 and the duplicate data transmitted from an external computer is received via the communication circuit 38 and the network, the duplicate data is input.

In the image forming apparatus 10 according to the first embodiment, if the duplicate data is input, it is determined whether the identification information included in the duplicate data (identification information on a duplicated data side) and the identification information stored in the image forming apparatus 10 (identification information on an apparatus side) match. If the input duplicate data is output from the image forming apparatus 10 (first apparatus), the identification information on the duplicate data side and the identification information on the apparatus side match. On the other hand, if the input duplicate data is output from another image forming apparatus (second apparatus) including a duplicate data output function, the identification information on the duplicated data side and the identification information on the apparatus side does not match.

In the image forming apparatus 10, if the identification information on the duplicate data side and the identification information on the apparatus side match, that is, if the duplicate data is duplicate data output from the image forming apparatus 10 (first apparatus), the common information and the unique information included in the duplicate data is set to the first apparatus. That is, the common information and the unique information included in the duplicate data are stored (written) in the storage 18.

On the other hand, in the image forming apparatus 10, if the identification information on the duplicate data side and the identification information on the apparatus side do not match, that is, if the duplicate data is duplicate data output from another image forming apparatus (second apparatus) including the duplicate data output function, only the common information, out of the information included in the duplicate data, is set to the first apparatus. At this time, the unique information included in the duplicate data is not set. That is, out of the information included in the duplicate data, only the common information is written in the storage 18.

When the duplicate data is input, if the common information or the unique information is already stored in the storage 18, the common information or the unique information already stored is overwritten (updated) with the common information or the unique information included in the duplicate data.

The above-described operation of the image forming apparatus 10 is realized by the CPU 12 executing a control program stored in the RAM 14. A specific process will be described below by using a flowchart.

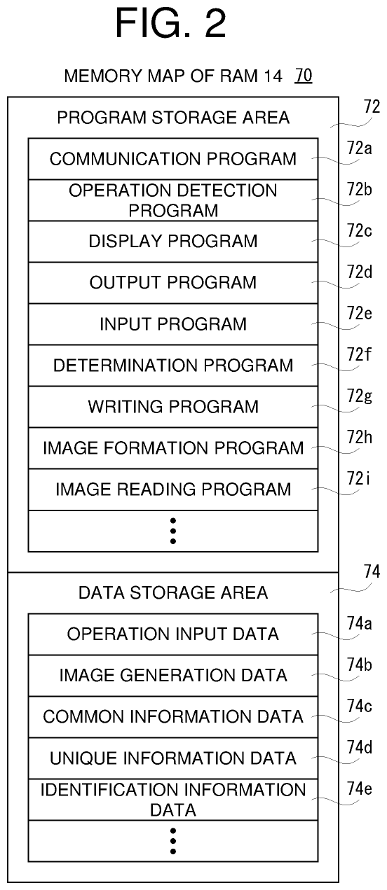

FIG. 2 is an illustrative view illustrating one example of a memory map 70 of the RAM 14 illustrated in FIG. 1. As illustrated in FIG. 2, the RAM 14 includes a program storage area 72 and a data storage area 74. As described above, a control program is stored in the program storage area 72 of the RAM 14. The control program includes a communication program 72a, an operation detection program 72b, a display program 72c, an output program 72d, an input program 72e, a determination program 72f, a writing program 72g, an image formation program 72h, and an image reading program 72i.

The communication program 72a is a program for communicating with an external computer such as another image forming apparatus or a server via a network.

The operation detection program 72b is a program for detecting an operation onto each processing operator of the image forming apparatus 10. For example, the operation detection program 72b is a program for acquiring touch coordinate data output from a touch panel and detecting that a software key included in various types of screens displayed on the display 26 is operated. The operation detection program 72b is also a program for detecting an operation input from a hardware-type operation button or operation key.

The display program 72c is a program for displaying various types of screens such as a home screen onto the display 26 by using image generation data 74b described later.

The output program 72d is a program for generating and outputting duplicate data at a time when an output operation is received, to a previously set output destination, if the output operation for instructing an output of the duplicate data is received.

The input program 72e is a program for receiving an input of duplicate data from outside.

The determination program 72f is a program for determining, if duplicate data is input, whether identification information on a duplicate data side included in the duplicate data and identification information on an apparatus side stored in the image forming apparatus 10 match.

The writing program 72g is a program for writing, if it is determined that the identification information on the duplicated data side and the identification information on the apparatus side match, common information and unique information included in the duplicate data into the storage 18, and writing, if it is determined that the identification information on the duplicated data side and the identification information on the apparatus do not match, the common information included in the duplicate data into the storage 18.

The image formation program 72h is a program for controlling the image former 32 to print (form) a multicolor image or a monochrome image onto a sheet.

The image reading program 72i is a program for controlling the image reader 34 to read an image of a document and outputting an image signal (image data) corresponding to the read image.

Although illustration is omitted, the program storage area 72 also stores a program and the like for selecting and executing various types of functions provided in the image forming apparatus 10.

The data storage area 74 of the RAM 14 stores operation input data 74a, image generation data 74b, common information data 74c, unique information data 74d, identification information data 74e, and the like.

The operation input data 74a is touch coordinate data or/and operation data detected (acquired) according to the operation detection program 72b, for example. The detected touch coordinate data and/or operation data is stored in time series.

The image generation data 74b is data including polygon data and texture data for generating display image data corresponding to various types of screens displayed on the display 26. An example of the image generation data 74b also includes software key image data.

The common information data 74c is data of common information applicable also to another image forming apparatus (second apparatus), from among the apparatus setting information. The unique information data 74d is data of unique information applicable only to the image forming apparatus from which the duplicate data is output, from among the apparatus setting information. It is noted that the common information data 74c and the unique information data 74d are stored in the storage 18 of the image forming apparatus 10, for example. The common information data 74c and the unique information data 74d are read from the storage 18 and stored in the RAM 14 as needed.

The identification information data 74e is data of the identification information for identifying the image forming apparatus 10 from which the duplicate data is output. It is noted that the identification information data 74e is stored in the ROM 16 of the image forming apparatus 10, for example. The identification information data 74e is read from the ROM 16 and stored in the RAM 14 as needed.

Although illustration is omitted, the data storage area 74 may store another data necessary for executing the control program, or may be provided with a timer (counter) and a register necessary for executing the control program.

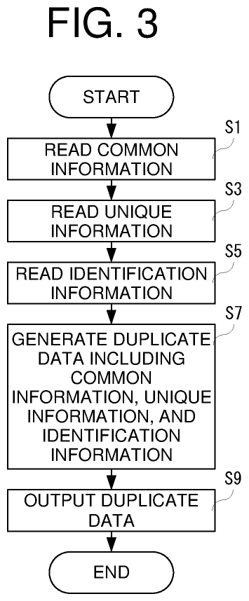

FIG. 3 is a flowchart illustrating an example of a duplicate data output process of the CPU 12 illustrated in FIG. 1. The duplicate data output process is started if an output operation for instructing an output of duplicate data is received.

As illustrated in FIG. 3, if the duplicate data output process is started, the CPU 12 reads common information from the storage 18 in step S1, reads unique information from the storage 18 in step S3, reads identification information from the ROM 16 in step S5, generates duplicate data including the common information, the unique information, and the identification information in step S7, outputs the duplicate data to a predetermined output destination in step S9, and ends the duplicate data output process.

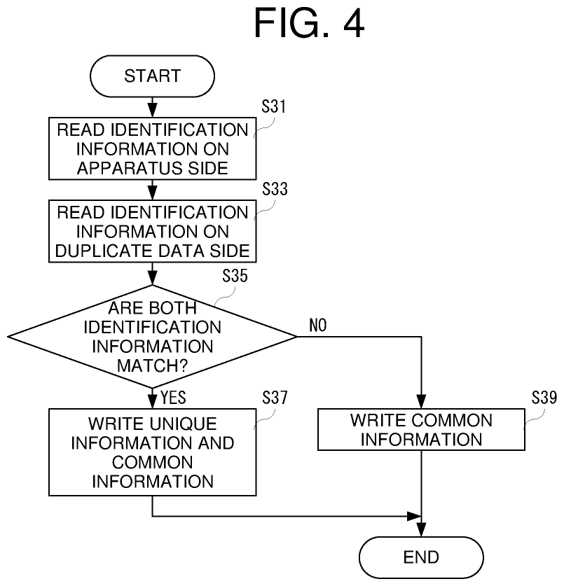

Next, a duplicate data writing process executed by the CPU 12 of the image forming apparatus 10 will be described. FIG. 4 is a flowchart illustrating an example of the duplicate data writing process by the CPU 12 illustrated in FIG. 1. The duplicate data writing process is started when duplicate data is input from outside.

As illustrated in FIG. 4, if the duplicate data writing process is started, the CPU 12 reads identification information on an apparatus side in step S31, reads identification information on a duplicate data side in step S33, and determines whether the identification information on the duplicate data side and the identification information on the apparatus side match in step S35.

If “YES” in step S35, that is, if it is determined that the identification information on the duplicate data side and the identification information on the apparatus side match, the CPU 12 writes the common information and the unique information included in the duplicate data into the storage 18 (sets the common information and the unique information to the first apparatus) in step S37, and ends the duplicate data writing process.

On the other hand, if “NO” in step S35, that is, if it is determined that the identification information on the duplicate data side and the identification information on the apparatus side do not match, the CPU 12 writes the common information included in the duplicate data into the storage 18 (sets the common information to the first apparatus) in step S39, and ends the duplicated data writing process.

According to the first embodiment, if the identification information on the duplicate data side and the identification information on the apparatus side do not match, only the common information included in the duplicate data is written into the storage 18. Therefore, the information unique to each apparatus is not implanted to another image forming apparatus, and thus, it is possible to improve safety when the device cloning function is utilized. If the identification information on the duplicate data side and the identification information on the apparatus side match, the common information and the unique information included in the duplicate data is written into the storage 18. Therefore, it is possible to use the duplicate data as backup data, and thus, it is possible to improve convenience when the device cloning function is utilized.

According to the first embodiment, the duplicate data including the identification information for identifying the image forming apparatus is output, and thus, it is possible to determine whether the duplicate data is output from the image forming apparatus 10 (first apparatus), or whether the duplicate data is output from another image forming apparatus (second apparatus). Thus, a process performed when the duplicate data is input is changed depending on whether the duplicate data is output from the first apparatus or output from the second apparatus, and thus, it is possible to achieve both convenience and safety when the device cloning function is utilized.

### Second Embodiment

The image forming apparatus 10 according to a second embodiment is configured in much the same way as in that in the first embodiment except that in the former, it is possible to set whether some or all of unique information is written, and thus, a technical feature different from that in the first embodiment will be described, and a duplicated technical feature will not be described.

In the second embodiment, unique information includes specific unique information by which it is possible for a user to set (select) whether to write duplicate data into the storage 18 (whether to set duplicate data to an image processing apparatus of the user) if the duplicate data is input. The specific unique information may be some of information included in the unique information or all the information included in the unique information.

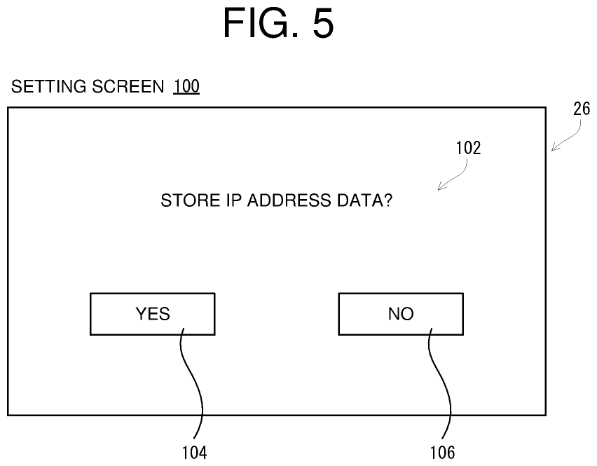

In the second embodiment, if identification information on the duplicate data side and identification information on the apparatus side match, a setting screen 100 as illustrated in FIG. 5 is displayed on the display 26 before the unique information included in the duplicate data is written into the storage 18. It is noted that FIG. 5 illustrates the setting screen 100 obtained when IP address information included in the unique information is specific unique information.

The setting screen 100 is an operation screen for the user to set whether to write the specific unique information into the storage 18, and a message (message asking whether to store “IP address data”, for example) 102 is displayed on the setting screen 100 for prompting to determine a permission/non-permission as to whether to write the specific unique information (IP address information) into the storage 18 (setting whether to write the specific unique information into the storage 18).

The setting screen 100 is displayed with a “Yes” button 104 to which a function of permitting the writing of the specific unique information into the storage 18 is assigned and a “No” button 106 to which a function of not permitting to write the specific information into the storage 18 is assigned.

If the “No” button 106 is selected, that is, if writing the specific information into the storage 18 is not permitted, the unique information other than the specific unique information is written into the storage 18. On the other hand, if the “Yes” button 104 is selected, that is, if writing the specific unique information into the storage 18 is permitted, the unique information including the specific unique information is written into the storage 18.

It is noted that if there are a plurality of specific unique information items, an operation screen allowing the user to set whether to write into the storage 18 for each specific unique information may be presented to the user to set whether to write into the storage 18 for each specific unique information.

In the second embodiment, to realize the above-described operation, a setting program and the like for setting whether to write the specific unique information into the storage 18 is included in the information processing program stored in the RAM 14 of the image forming apparatus 10.

The duplicate data writing process according to the second embodiment will be described below by using a flowchart. The same reference numerals are assigned to the same processes as those in the duplicated data writing process described in the first embodiment, and the duplicated technical feature will not be described or simply described.

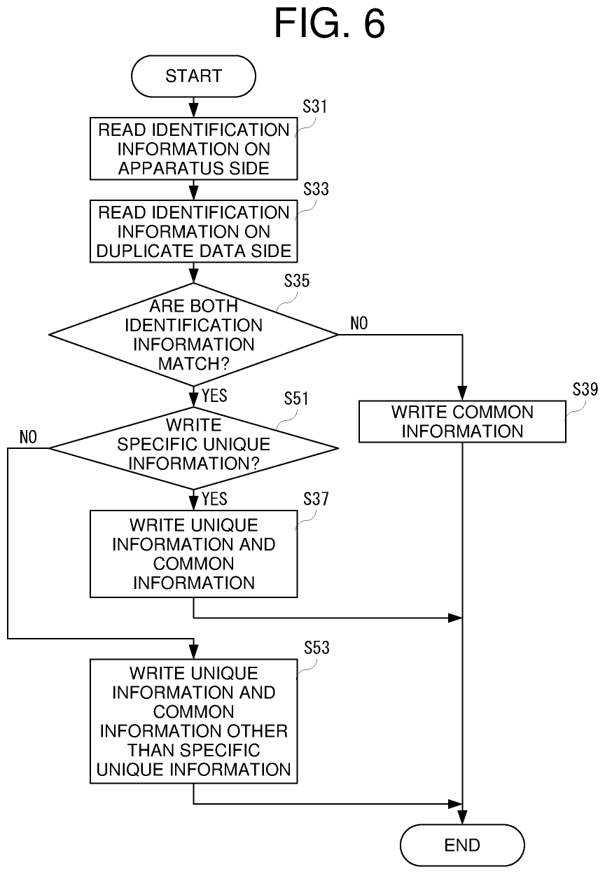

FIG. 6 is a flowchart illustrating an example of the duplicate data writing process of the image forming apparatus 10 according to the second embodiment. As illustrated in FIG. 6, when the duplicate data writing process is started, the CPU 12 of the image forming apparatus 10 determines whether to write the specific unique information in step S51 if “YES” in step S35.

If “NO” in step S51, that is, if it is determined that the specific unique information is not written, the unique information other than the specific unique information and the common information are written into the storage 18 in step S53, and the duplicate data writing process ends. On the other hand, if “YES” in step S51, that is, if it is determined that the specific unique information is written, the unique information including the specific unique information and the common information are written into the storage 18 in step S37, and the duplicate data writing process ends.

It is noted that the technical feature in the processes up to step S35 and that in step S39 are the same as those in the first embodiment, and thus, description thereof will be omitted. The technical feature of the duplicate data output process is the same as that of the first embodiment, and therefore, description thereof will be omitted.

According to the second embodiment, it is possible to set whether to write some or all of the unique information, and thus, it is possible to improve the convenience when the device cloning function is utilized.

The numerical values, the screen, the specific configuration, and the like described in the above embodiments are merely examples, and may be appropriately changed according to an actual product. The order in which each step in the flowcharts illustrated in the above embodiments is processed may be appropriately changed as long as the same result is obtained.

The operation condition information described in the above embodiments may include not only information about a content of a specific operation condition, but also information (change information) as to whether each operation condition is changed from a default (initial setting). In this case, an operation condition not changed from an initial setting, out of the operation condition information, when duplicate data is input, maintains the initial setting. For example, if an initial setting of a sheet size of the image forming apparatus 10 from which duplicate data is output is “B4” and an initial setting of a sheet size of the image forming apparatus 10 into which the duplicate data is input is “A4”, and if information about a sheet size included in the duplicate data is an initial setting, setting of the sheet size of the image forming apparatus 10 into which the duplicate data is input maintains “A4”. However, a setting screen allowing a user to set whether the initial setting of the image forming apparatus 10 into which the duplicate data is input is maintained, or whether the initial setting of the image forming apparatus 10 from which the duplicate data is output is adopted may be presented to the user so that the user may select whether to maintain the initial setting of the image forming apparatus 10 into which the duplicate data is input, or whether to adopt the initial setting of the image forming apparatus 10 from which the duplicate data is output.

### DESCRIPTION OF REFERENCE NUMERALS

10 Image forming apparatus

12 CPU

14 RAM

16 ROM

18 Storage

38 Communication circuit

What is claimed is:

1. An image forming apparatus including a storage and an image former that forms an image on a recording medium, comprising:
an inputter that receives an input of duplicate data obtained by duplicating: common information applicable also to another image forming apparatus, out of setting information about the image forming apparatus; unique information applicable only to the image forming apparatus, out of the setting information; and identification information for identifying the image forming apparatus;
a determiner that determines, if the duplicate data is input, whether identification information on a duplicate data side included in the duplicate data and identification information on an apparatus side stored in the storage match; and
a writer that writes, if it is determined that the identification information on the duplicate data side and the identification information on the apparatus side match, the unique information included in the input duplicate data into the storage.

2. The image forming apparatus according to claim 1, wherein if the duplicate data is input, the writer writes the common information included in the duplicate data into the storage.

3. The image forming apparatus according to claim 1, wherein the unique information includes specific unique information,
the image forming apparatus further includes a setter that sets whether to write the specific unique information, and
the writer writes the specific unique information into the storage if there is a setting to write the specific information.

4. An image forming apparatus including an image former that forms an image on a recording medium, comprising:
a storage that stores common information applicable also to another image forming apparatus, out of setting information about the image forming apparatus, unique information applicable only to the image forming apparatus, out of the setting information, and identification information for identifying the image forming apparatus; and
an outputter that outputs duplicate data obtained by duplicating the common information, the unique information, and the identification information.

5. A non-transitory storage medium for storing a control program of an image forming apparatus including a storage and an image former that forms an image on a recording medium, the control program causing
a processor of the image forming apparatus to execute:
receiving an input of duplicate data obtained by duplicating: common information applicable also to another image forming apparatus, out of setting information about the image forming apparatus; unique information applicable only to the image forming apparatus, out of the setting information; and identification information for identifying the image forming apparatus;
determining, if the duplicate data is input, whether identification information on a duplicate data side included in the duplicate data and identification information on an apparatus side stored in the storage match; and
writing, if it is determined that the identification information on the duplicate data side and the identification information on the apparatus side match, the unique information included in the input duplicate data into the storage.

6. A control method of an image forming apparatus including a storage and an image former that forms an image on a recording medium, comprising:
(a) receiving an input of duplicate data obtained by duplicating: common information applicable also to another image forming apparatus, out of setting information about the image forming apparatus; unique information applicable only to the image forming apparatus, out of the setting information; and identification information for identifying the image forming apparatus;
(b) determining, if the duplicate data is input, whether identification information on a duplicate data side included in the duplicate data and identification information on an apparatus side stored in the storage match; and
(c) writing, if it is determined that the identification information on the duplicate data side and the identification information on the apparatus side match, the unique information included in the input duplicate data into the storage.
